(19) United States
(12) Patent Application Publication
(10) Pub. No.: US 2025/0062622 A1
(43) Pub. Date: Feb. 20, 2025

(54) DISTRIBUTED ENERGY RESOURCES AGGREGATED OPTIMIZATION

(71) Applicant: Itron, Inc., Liberty Lake, WA (US)

(72) Inventors: Jered Adam Myers, Spokane Valley, WA (US); Howard Ng, Towaco, NJ (US)

(21) Appl. No.: 18/235,103

(22) Filed: Aug. 17, 2023

(51) Int. Cl. H02J 3/38; G05B 15/02; H02J 3/00

(52) U.S. Cl. CPC H02J 3/381; G05B 15/02; H02J 3/003; H02J 2300/24

(57) ABSTRACT

A method and system for managing demand and electricity supply are disclosed. A distributed energy resource optimizer (DERO) of the system may determine demand for electricity associated with a plurality of premises connected to an electrical grid where the plurality of premises includes one or more distributed generation systems, determine available electricity supply for the plurality of premises, and compare the demand with the available electricity supply. In response to determining that the demand is higher than the available electricity supply, the DERO may cause one or more storage devices associated with the one or more distributed generation systems to supply electricity to the plurality of premises. In response to determining that the demand is lower than the available electricity supply, the DERO may cause the one or more storage devices to store excess electricity supply.

### TECHNICAL FIELD

The present disclosure generally relates to the field of electrical supply and load management, and more specifically to methods, apparatus, and system for adjusting both electrical supply and load at an individual meter level based on demand.

### BACKGROUND

Demand for electricity changes throughout the day. The change in demand is driven by many factors including weather, temperature, number of electricity consuming devices, and number of residential electricity generating devices. However, electricity supply does not always match the demand for electricity.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example power distribution environment.

FIG. 2 illustrates a plurality of premises equipped with distributed generation systems.

FIG. 3 illustrates an example environment in which a load control system comprising a distributed energy resource optimizer (DERO) may be utilized when the demand is high.

FIG. 4 illustrates an example environment in which the DERO may be utilized when the demand is low.

FIG. 5 illustrates example components involved in the DERO.

FIG. 6 illustrates an example process in which the DERO controls aspects of the demand and/or the available electricity supply.

### DETAILED DESCRIPTION

Systems and methods for managing distribution of electrical power and loads are disclosed.

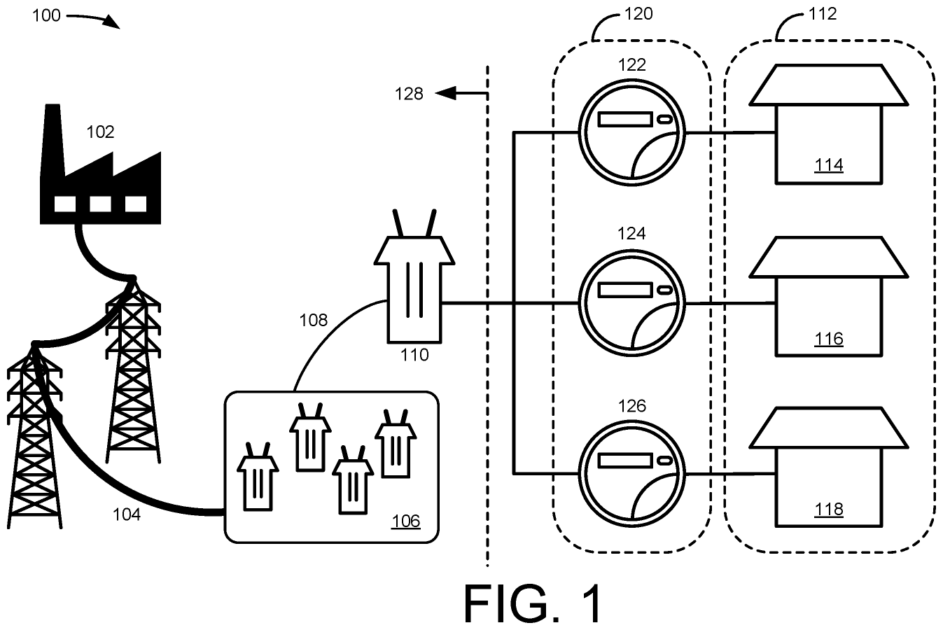

FIG. 1 illustrates an example power distribution environment 100. In this example, a power plant 102 generates electricity, which is carried by high voltage lines, or transmission lines, 104 to a power substation 106. The power plant 102 includes power plants based on traditional centrally generated energy sources such as fossil fuel, hydroelectric, and/or nuclear, as well as renewable energy sources such as wind and solar. The power substation 106 provides electricity via a feeder 108 to a transformer 110. The feeder 108 is a power line consisting of individual powered lines servicing a plurality of premises 112 (three individual premises 114, 116, and 118 are shown in this example though the number of premises can be more or less in other examples) connected via the transformer 110 and a plurality of electricity metering devices 120 (three individual electricity meters 122, 124, and 126 as electricity metering devices are shown in this example) associated the plurality of premises 112. The plurality of premises 112 may include residential premises, commercial premises, electric vehicle supply equipment (EVSE), and the like. In this example, the transformer 110 is shown to be connected to the feeder 108 and represents a connection to a portion of the electrical grid 128 which comprises power plants 102, power substations 106, transmission lines 104, and other electric components (not shown). FIG. 1 is just a simplified example, and in practice any number of each of the illustrated components may be present.

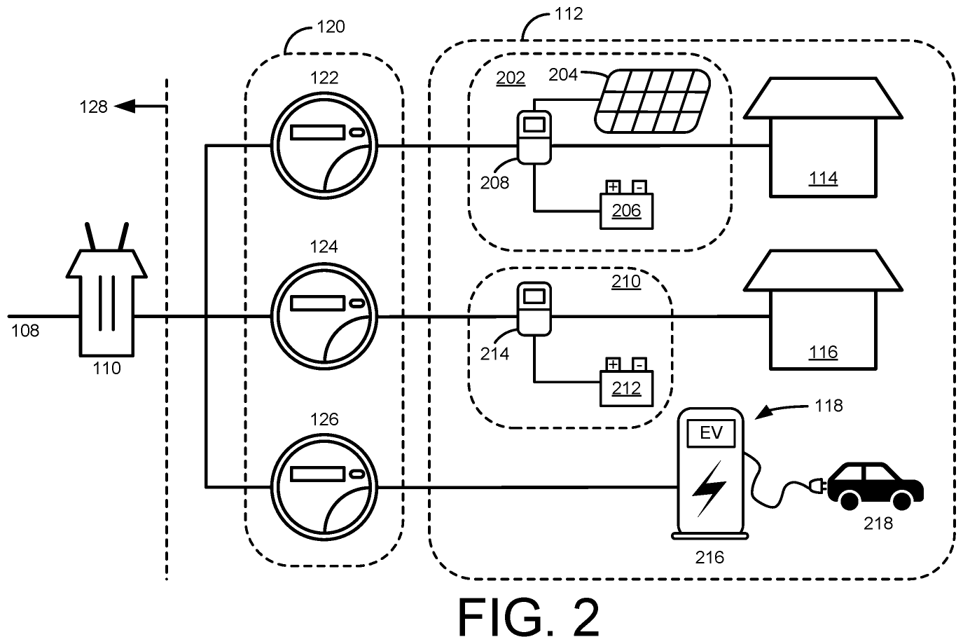

FIG. 2 illustrates the plurality of premises 112 equipped with distributed generation systems. In this example, the premises 114 is shown to be equipped with a photovoltaic (PV) system 202 as a distributed generation system comprising a solar power panel 204, a PV battery module 206, and an inverter 208. The inverter 208 may direct electricity generated by the solar power panel 204 to the premises 114 for consumption, to the PV battery module 206 for storage, and/or to the electrical grid 128. The inverter 208 may also direct the stored electricity from the PV battery module 206 to the premises 114, under some circumstances, such as during a power outage, for consumption at the premises 114. Additionally, or alternatively, the inverter 208 may also direct, or be instructed to direct, the stored electricity from the PV battery module 206 to the electrical grid 128 during a peak demand period.

The premises 116 is shown to be equipped with a battery backup system 210 as a distributed generation system comprising a backup battery module 212 and an inverter 214. The inverter 214 may normally direct electricity from the electrical grid 128 to the backup battery module 212 for storage during a scheduled time period, for example, corresponding to non-peak hours, and may direct the stored electricity from the backup battery module 212 to the premises 116, under some circumstances, such as during a power outage, for consumption at the premises 116. Additionally, or alternatively, the inverter 214 may also direct, or be instructed to direct, the stored electricity from the backup battery module 212 to the electrical grid 128 during a peak demand period.

The premises 118 is shown as an electric vehicle supply equipment (EVSE) 216 as a distributed generation system. The EVSE 216 may charge an electric vehicle (EV) 218 when the EVSE 216 is plugged into EV 218. Additionally, or alternatively, the EVSE 216 may charge the EV 218 based on a charging schedule. For example, while the EVSE 216 is plugged into EV 218, the EVSE 216 may become active only during a scheduled time, such as during non-peak hours (between 10 μm and 6 am for example), to charge the EV 218. The EVSE 216 may also be set to charge the EV 218 at a certain battery charging rate and/or when the cost of electricity, such as $/kWh, is below a preselected cost. Additionally, or alternatively, the EVSE 216 may also direct, or be instructed to direct, the stored electricity from a battery or batteries of the EV 218 to the electrical grid 128 during a peak demand period.

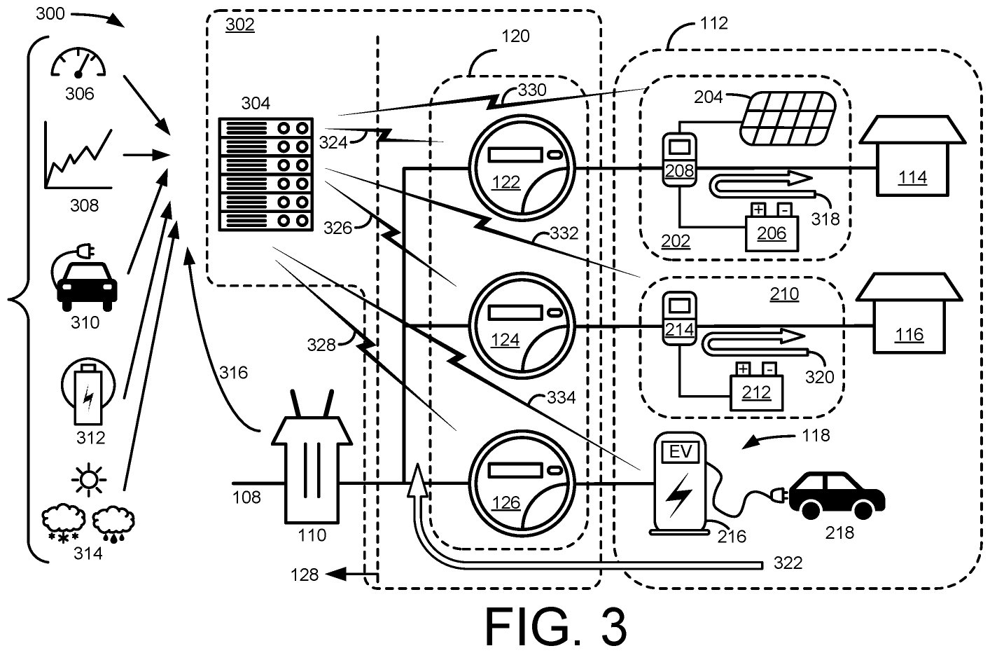

FIG. 3 illustrates an example environment 300 in which a load control system 302 comprising a distributed energy resource optimizer (DERO) 304 and the plurality of electricity metering devices 120 may be utilized when the demand is high. The demand may in some circumstances exceed the available power due to a number of reasons, such as many consumers simultaneously charging electric vehicles at night at home, extreme weather conditions in which a large number of consumers are expected to continuously use heating or cooling equipment, or the like. The demand may also exceed the available power due to variations in power production (e.g., at night for solar power generation, on days with little or no wind for wind generation, etc.), if one or more power generators or sources go offline, and/or if some transmission lines become disconnected and fail to provide power from the generators to some parts of the electrical grid 128. To maintain the integrity of the electrical grid 128 and avoid a catastrophic grid failure, the demand needs be reduced, or the supply, at least temporarily, needs to be increased.

When the load control system 302 comprising the DERO 304, identifies a scenario where demand is high, the DERO 304 works to reduce demand, or temporarily increase supply, to increase reliability and save on infrastructure wear and energy generation costs. In this example, the DERO 304 is shown as a server but may be hosted by the server or be distributedly hosted in a cloud environment. In some examples, at least a portion of the load control functionality attributed to the DERO 304 may be performed locally at one or more transformers, meters, or other network devices. The DERO 304 may take actions with an understanding of both load and energy generation, for example, in both the load and generation use cases, by performing calculations based on what is controllable and what is uncontrollable. The DERO 304 may take into consideration various factors, parameters, and conditions including an overall load or demand 306, load forecast 308, EV load 310, battery levels 312 of batteries connected to the electrical grid 128, weather information 314 including the current weather and forecast, and the like.

The DERO 304 may determine overall demand 306 for electricity associated with the plurality of premises 112 connected to the electrical grid 128. As discussed above with reference to FIG. 2, the plurality of premises 112 may include one or more distributed generation systems, such as the PV system 202 with the PV battery module 206 and the backup battery module 212. The EV 218 may also be considered as a distributed generation system based on its ability to store and discharge electricity similar to the backup battery module 212. The DERO 304 may determine available electricity supply for the plurality of premises 112. The DERO 304 may determine the levels of the demand 306 and the available electricity supply 316 at the transformer 110, and compare the demand 306 with the available electricity supply 316. In response to determining that the demand 306 is higher than a first predetermined amount of the available electricity supply 316, for example, the demand 306 is more than 90% of the available electricity supply 316, the DERO 304 may cause one or more storage devices, including the PV battery module 206, the backup battery module 212, and/or the EV 218, to supply electricity directly as shown by arrows 318 and 320, or indirectly as shown by arrow 322 via the electrical grid 128, to the plurality of premises 112.

The DERO 304 may cause the one or more storage devices (e.g., PV battery module 206, backup battery module 212, and EV 218) to supply electricity by communicating instructions to the plurality of electricity metering devices 120 as shown by arrows 324, 326, and 328, which then controls the associated distributed generation systems, for example, via the corresponding inverters, such as the inverters 208 and 214 and an inverter of the EVSE 216. Additionally, or alternatively, the DERO 304 may communicate the instructions directly to the associated distributed generation systems such as the PV system 202, the backup system, and the EVSE 216 as shown by arrows 330, 332, and 334, or to the corresponding inverters, such as the inverters 208 and 214 and an inverter of the EVSE 216.

The DERO 304 may communicate with the plurality of electricity metering devices 120 to provide various instructions including the instruction to supply electricity as discussed above. While in this example, the DERO 304 is shown to communicate with the electricity meters 122, 124, and 126, which may be smart electricity meters, and associated distributed generation systems (e.g., PV system 202, battery backup system 210, and EVSE 216) wirelessly, as shown by arrows 324, 326, 328, 330, 332, and 334, respectively, the communications between the DERO 304 and the electricity meters 122, 124, and 126, and associated distributed generation systems may also be established in various ways, such as via a cellular network, Wi-Fi network, other radio frequency (RF) network, cable network, landline telephone network, the internet, and the like.

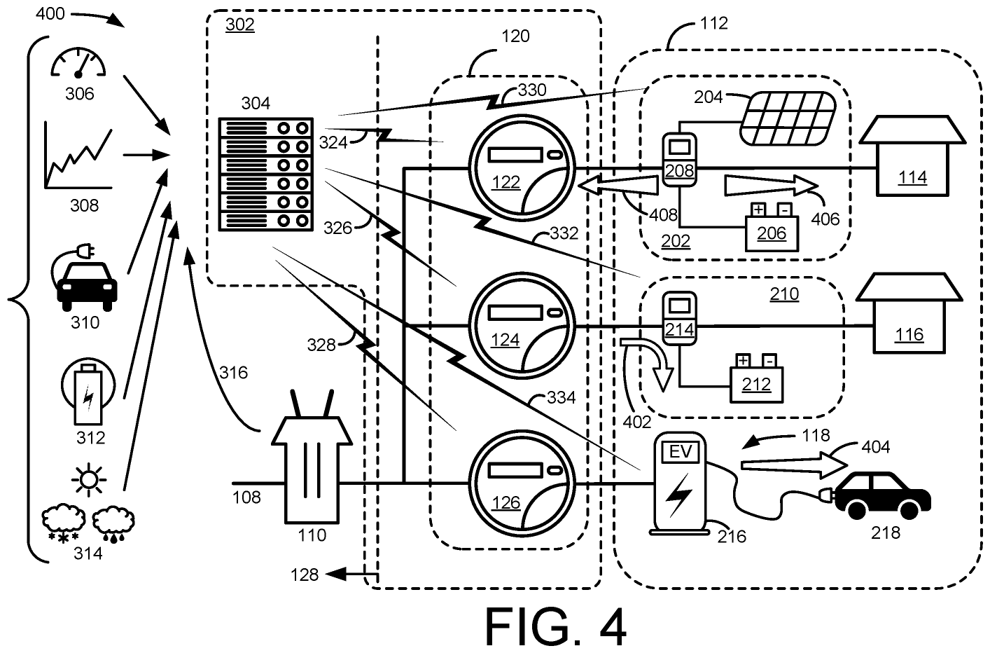

FIG. 4 illustrates an example environment 400 in which the DERO 304 may be utilized when the demand is low. In response to determining that the demand 306 is lower than a second predetermined amount of the available electricity supply 316, for example, the demand 306 is less than 80% of the available electricity supply 316, the DERO 304 may cause the one or more storage devices to store excess electricity supply over the demand 306. To store the excess electricity supply in the one or more storage devices (e.g., PV battery module 206, backup battery module 212, and EV 218) associated with the plurality of premises 112, the DERO 304 may cause the one or more storage devices to be available for charging by adjusting charging schedules of the one or more storage devices. For example, while the backup battery module 212 may be scheduled to be charged overnight from 11 PM to 5 AM, the DERO 304 may override or change the charging schedule to make the backup battery module 212 available to store charge, as shown by arrow 402, outside of the charging schedule in response to determining that the demand 306 is less than the second predetermined amount of the available electricity supply 316. Similarly, the charging schedule of the EV 218 may be changed at the EVSE 216 to charge the EV 218 with the excess electricity. Additionally, or alternatively, the DERO 304 may increase battery charging rates of the one or more storage devices, as shown by an increasing arrow 404 for the EVSE 216 and the EV 218. Additionally, or alternatively, the DERO 304 may reduce electricity supplied by the one or more distributed generation systems, such as the PV system 202, to the electrical grid 128 and to the plurality of premises 112 as shown by decreasing arrows 406 and 408. Additionally, or alternatively, the DERO 304 may increase a temperature setting of water heaters associated with the plurality of premises 112, for example, from a normal setting of 140° F. to a temporary setting of 150° F.

The DERO 304 may cause the one or more storage devices, such as PV battery module 206, backup battery module 212, and EV 218, to store excess electricity supply by sending instructions to the inverters, such as the inverters 208 and 214 and an inverter of the EVSE 216, associated the one or more storage devices. Additionally, or alternatively, the DERO 304 may send the instructions to the plurality of electricity metering devices 120, which then forwards the instructions to the corresponding inverters.

To ensure that the storages devices are capable of safely charging and discharging, in response to comparing the demand 306 with the available electricity supply 316, the DERO 304 may select the one or more storage devices, such as the PV battery module 206, the backup battery module 212, and the EV 218, based on at least one of state of charge of the one or more storage devices, or state of health of the one or more storage devices such that the selected one or more storage devices are capable of discharging electricity to the electrical grid 128 or to the plurality of premises 112, or capable of storing the excess electricity supply over the demand 306.

As discussed above with reference to FIGS. 3 and 4, the DERO 304 may take into consideration various factors, parameters, and conditions. To determine the demand 306 for the plurality of premises 112, the DERO 304 may receive electricity usage data of the plurality of premises 112 via the plurality of electricity metering devices 120, and determine the demand 306 based at least in part on the electricity usage data. Additionally, or alternatively, the DERO 304 may receive the electricity usage data of the plurality of premises 112 from the one or more distributed generation systems associated with the plurality of premises such as the PV system 202, the battery backup system 210, and the EVSE 216, EV telematics of one or more EVs connected to the electrical grid 128, or one or more EVSE network systems associated with the electrical grid 128. The electricity usage data may include present, or real-time, electricity consumption data associated with the plurality of premises 112, historical electricity consumption data associated with the plurality of premises 112, present, or real-time, electricity generation data associated with the one or more distributed generation systems (e.g., PV system 202, battery backup system 210, and EVSE 216), and historical electricity generation data associated with the one or more distributed generation systems. The DERO 304 may receive electricity usage data at a regular interval, such as every 15 minutes, or on an as-needed basis based on the electricity usage data, from the plurality of electricity metering devices 120. The electricity meters 122, 124, and 126 may transmit the electricity usage data at the regular interval or when an unusual activity, such as a higher than expected consumption, is detected, or in response to a request for the electricity usage data from the DERO 304.

The DERO 304, for example, may determine, or generate a forecast, that is, a predicted demand and predicted available supply, associated with the plurality of premises 112 based at least in part on the historical electricity consumption data associated with the plurality of premises 112. The historical electricity consumption data may include electricity usage or consumption amount by the plurality of premises 112 and electricity generated by the distributed generation systems (e.g., PV system 202, battery backup system 210, and EVSE 216) (when used as a supply) based on seasons, day-of-the-month, day-of-the-week, time-of-the-day, weather and temperature conditions, EV-related usage, and the like. Additionally, the DERO 304 may generate event recommendations regarding the forecast, and provide the forecast and the event recommendations to a utility provider associated with the plurality of premises 112. The forecast may be targeted for the feeder 108 and/or load level at the transformer 110.

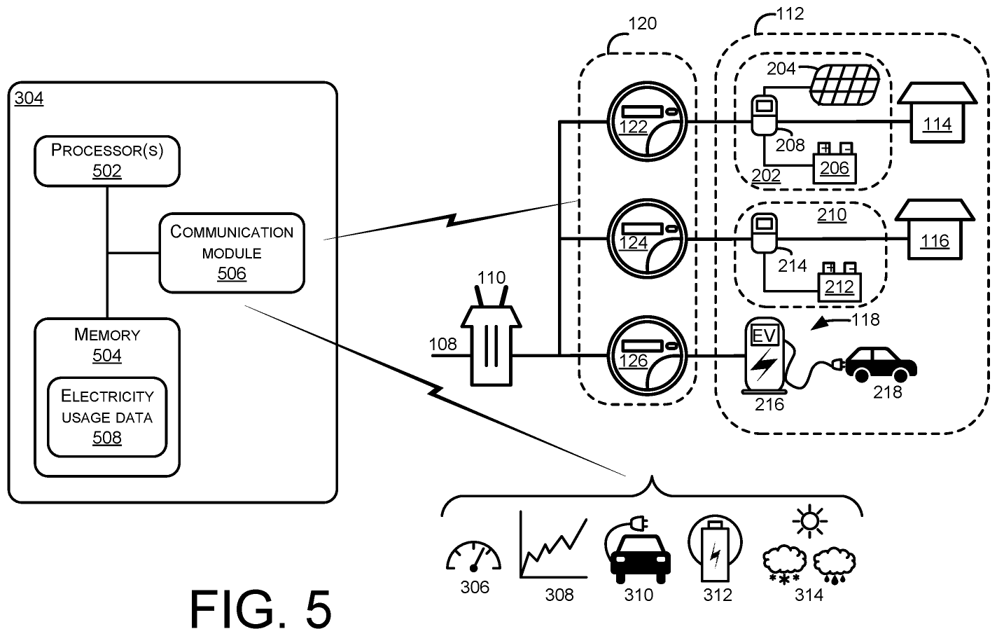

FIG. 5 illustrates example components involved in the DERO 304. As described above with reference to FIG. 3, the DERO 304 may be hosted by a single server or distributedly hosted by a plurality of servers in a cloud environment. The DERO 304 may comprise one or more processors 502, memory 504 communicatively coupled to the processors 502, and a communication module 506 communicatively coupled to the processors 502 and the memory 504. The DERO 304 may receive, or collect, via the communication module 506, and store in the memory 504, various factors, parameters, and conditions including the overall load or the demand 306, the load forecast 308, the EV load 310, the battery levels 312 of batteries connected to the electrical grid 128, the weather information 314 including the current weather and forecast, and the like as described above with reference to FIG. 3. The DERO 304 may also receive electricity usage data 508 from the plurality of electricity metering devices 120 via the communication module 506. As discussed above with reference to FIGS. 3 and 4, the electricity usage data 508 may include present, or real-time, electricity consumption data associated with the plurality of premises 112, historical electricity consumption data associated with the plurality of premises 112, present, or real-time, electricity generation data associated with the one or more distributed generation systems (e.g., PV system 202, battery backup system 210, and EVSE 216), and historical electricity generation data associated with the one or more distributed generation systems. The historical electricity consumption data may include electricity usage or consumption amount by the plurality of premises 112 and electricity generated by the distributed generation system (when used as a supply) based on seasons, day-of-the-month, day-of-the-week, time-of-the-day, weather and temperature conditions, EV-related usage, and the like.

As described above with reference to FIG. 3, in response to determining that the demand 306 is higher than the first predetermined amount of the available electricity supply 316, the DERO 304 may cause the one or more storage devices to supply electricity directly, or indirectly, to the plurality of premises 112. As described above with reference to FIG. 4, in response to determining that the demand 306 is lower than the second predetermined amount of the available electricity supply 316, the DERO 304 may cause the one or more storage devices to store excess electricity supply over the demand 306.

The software and or functionality of the tool(s), system(s), resource(s), cloud(s), platform(s), etc., discussed above with reference to FIGS. 1-5 regarding the DERO 304 may be combined in different ways depending on design requirements, ease of construction and/or integration, cost, etc. Accordingly, while these elements have been separated for purposes of discussion, they may be combined, as appropriate, during implementation.

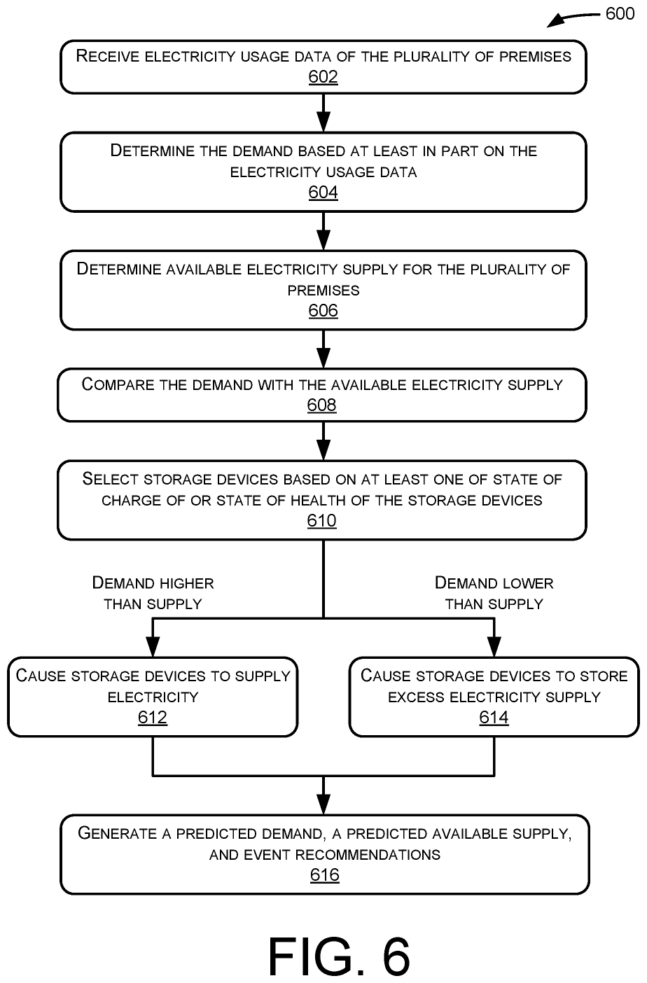

FIG. 6 illustrates an example process 600 in which the DERO 304 performs control the demand 306 and the available electricity supply 316. At block 602, the DERO 304 may receive electricity usage data of the plurality of premises 112, and determine the demand based at least in part on the electricity usage data at block 604. As discussed above with reference to FIGS. 1-5, the plurality of premises 112 includes one or more distributed generation systems, such as the PV system 202, the battery backup system 210, and the EVSE 216. The electricity usage data may include present, or real-time, electricity consumption data associated with the plurality of premises 112, historical electricity consumption data associated with the plurality of premises 112, present, or real-time, electricity generation data associated with the one or more distributed generation systems (e.g., PV system 202, battery backup system 210, and EVSE 216), and historical electricity generation data associated with the one or more distributed generation systems. The DERO 304 may determine the demand 306 based at least in part on the historical electricity consumption data associated with the plurality of premises 112. The DERO 304 may receive electricity usage data of the plurality of premises 112 via the plurality of electricity metering devices 120, such as the electricity meters 122, 124, and 126, which may be smart meters, the one or more distributed generation systems associated with the plurality of premises, such as the PV system 202, the battery backup system 210, and the EVSE 216, EV telematics of one or more EVs connected to the electrical grid 128, or one or more EVSE network systems associated with the electrical grid 128.

At block 606, the DERO 304 may determine available electricity supply 316 for the plurality of premises 112. The DERO 304 may determine the levels of the demand 306 and the available electricity supply 316 at the transformer 110, and compare the demand 306 with the available electricity supply 316 at block 608. At block 610, the DERO 304 may select one or more storage devices, such as the PV battery module 206, the backup battery module 212, and the EV 218, based on at least one of state of charge of the one or more storage devices, or state of health of the one or more storage devices such that the selected one or more storage devices are capable of safely discharging electricity to the electrical grid 128 or to the plurality of premises 112, or capable of safely storing the excess electricity supply over the demand 306.

At block 612, in response to determining that the demand 306 is higher than a first predetermined amount of the available electricity supply 316, for example, the demand 306 is more than 90% of the available electricity supply 316, the DERO 304 may cause one or more storage devices, including the PV battery module 206, the backup battery module 212, and the EV 218, to supply electricity directly, or indirectly to the plurality of premises 112. At block 614, in response to determining that the demand 306 is lower than a second predetermined amount of the available electricity supply 316, for example, the demand 306 is less than 80% of the available electricity supply 316, the DERO 304 may cause the one or more storage devices to store excess electricity supply over the demand 306. For example, the DERO 304 may cause the one or more storage devices to become available for charging by adjusting charging schedules of the one or more storage devices, increase the battery charging rates of the one or more storage devices, or reduce electricity supplied by the one or more distributed generation systems to the electrical grid 128 as discussed above with reference to FIG. 4. The DERO 304 may cause the one or more storage devices, such as PV battery module 206, backup battery module 212, and EV 218, to supply electricity or to store excess electricity supply by sending instructions to the inverters, such as the inverters 208 and 214 and an inverter of the EVSE 216, associated the one or more storage devices. Additionally, or alternatively, the DERO 304 may send the instructions to the plurality of electricity metering devices 120, which then forwards the instructions to the corresponding inverters.

At block 616, the DERO 304 may determine, or generate a forecast, that is, a predicted demand and predicted available supply, associated with the plurality of premises 112 based at least in part on the historical electricity consumption data associated with the plurality of premises 112. Additionally, the DERO 304 may generate event recommendations regarding the forecast, and provide the forecast and the event recommendations to a utility provider associated with the plurality of premises 112. The forecast may be targeted for the feeder 108 and/or load level at the transformer 110.

The DERO 304 may communicate with the plurality of electricity metering devices 120, which may be smart electricity meters, to provide various instructions including the instruction to the distributed generation systems to supply electricity and store electricity as discussed above. The DERO 304 may additionally communicate with the one or more distributed generation systems associated with the plurality of premises, such as the PV system 202, the battery backup system 210, and the EVSE 216, EV telematics of one or more EVs connected to the electrical grid 128, or one or more EVSE network systems associated with the electrical grid 128. The DERO 304 may also receive third party subscription data, such as the load forecast 308, the EV load 310, the battery levels 312 of batteries connected to the electrical grid 128, the weather information 314 including current and historical weather data, and the like as discussed above with reference to FIG. 3. While the communications with the DERO 304 have been described above as wireless communications, the communications between the DERO 304 and various components described above may also be established in various ways, such as via a cellular network, Wi-Fi network, other radio frequency (RF) network, cable network, landline telephone network, the internet, and the like.

Some or all operations of the methods described above can be performed by execution of computer-readable instructions stored on a computer-readable storage medium, as defined below. The terms “computer-readable medium,” “computer-readable instructions,” and “computer executable instructions” as used in the description and claims, include routines, applications, application modules, program modules, programs, components, data structures, algorithms, and the like. Computer-readable and -executable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (RAM)) and/or non-volatile memory (such as read-only memory (ROM), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media, when executed by one or more processors, may perform operations described above with reference to FIGS. 2-6. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

For example, a method may comprise determining demand for electricity associated with a plurality of premises connected to an electrical grid where the plurality of premises includes a distributed generation system associated with one of the plurality of premises, determining available electricity supply for the plurality of premises, comparing the demand with the available electricity supply, in response to determining that the demand is higher than a first predetermined amount of the available electricity supply, supplementing the available supply by causing a storage device associated with the distributed generation system to supply electricity to the electrical grid, and in response to determining that the demand is lower than a second predetermined amount of the available electricity supply, storing excess electricity supply over the demand in the storage device. The method may further comprise, in response to comparing the demand with the available electricity supply, selecting the storage device from multiple storage devices based on at least one of state of charge of the storage device, or state of health of the storage device.

Storing the excess electricity supply in the storage device may include at least one of causing the storage device to be available for charging by adjusting a charging schedule of at least one of the multiple storage devices, or increasing a battery charging rate of at least one of the multiple storage devices, and the method may further comprise, in response to determining that the demand is lower than a second predetermined amount of the available electricity supply, reducing electricity supplied by the distributed generation system to the electrical grid.

Determining the demand associated with the plurality of premises may include receiving electricity usage data of the plurality of premises, and determining the demand based at least in part on the electricity usage data. Receiving the electricity usage data of the plurality of premises may include receiving the electricity usage data from at least one of: electricity metering devices associated with the plurality of premises, the distributed generation system, electric vehicle (EV) telematics of one or more EVs connected to the electrical grid, or one or more EV supply equipment (EVSE) associated with the electrical grid.

The electricity usage data may include present electricity consumption data associated with the plurality of premises, historical electricity consumption data associated with the plurality of premises, present electricity generation data associated with the one or more distributed generation systems, and historical electricity generation data associated with the one or more distributed generation systems, and determining the demand associated with the plurality of premises may further include determining the demand based at least in part on the historical electricity consumption data associated with the plurality of premises. The method may further comprise providing a forecast to a utility provider associated with the plurality of premises based at least in part on the electrical usage data, the forecast including at least one of predicted demand, predicted available supply, or event recommendations.

Determining the demand may include determining a demand level at a transformer associated with the plurality of premises, and determining the available electricity supply may include determining a supply level available at the transformer.

A distributed energy resource optimizer (DERO) may comprise one or more processors, and memory communicatively coupled to the one or more processors. The memory may store thereon computer executable instructions that, when executed by the one or more processors, cause the one or more processors to perform operations. The operations may comprise receiving electricity usage data from a plurality of electricity metering devices associated with a plurality of premises, determining demand for electricity at a transformer associated with the plurality of electricity metering devices connected to an electrical grid, where the electrical grid including a distributed generation system associated with one of the plurality of premises, determining available electricity supply at the transformer for the plurality of premises, comparing the demand with the available electricity supply, in response to determining that the demand is higher than a first predetermined amount of the available electricity supply, causing a storage device associated with the distributed generation system to supply electricity to the electrical grid, and in response to determining that the demand is lower than a second predetermined amount of the available electricity supply, causing the storage device to store excess electricity supply. The operations may further comprise, in response to comparing the demand with the available electricity supply, selecting the storage device based on at least one of state of charge of the storage device, or state of health of the storage device.

Causing the storage device to store the excess electricity supply may include adjusting a charging schedule of at least one of multiple storage devices to be available for charging, increasing a battery charging rate of at least one of the multiple storage devices, or controlling the distributed generation system via an electricity metering device of the plurality of metering devices.

In response to determining that the available electricity supply exceeds the demand, the one or more processors may be caused to send instructions to one or more electricity metering devices of the plurality of electricity metering devices to reduce electricity supplied to the electrical grid by at least one of one or more distributed generation systems corresponding to the one or more electricity metering devices.

The electricity usage data includes present electricity consumption data associated with the plurality of premises, present electricity generation data associated with the one or more distributed generation systems, historical electricity consumption data associated with the plurality of premises, and historical electricity generation data associated with the one or more distributed generation systems.

A non-transitory computer-readable storage medium may store thereon computer executable instructions that, when executed by one or more processors, cause the one or more processers to perform operations. The operations may comprise receiving electricity usage data from a plurality of electricity metering devices associated with a plurality of premises, determining demand for electricity at a transformer associated with the plurality of electricity metering devices connected to an electrical grid, the electrical grid including a distributed generation system associated with one of the plurality of premises, determining available electricity supply at the transformer for the plurality of premises, comparing the demand with the available electricity supply, in response to determining that the demand is higher than a first predetermined amount of the available electricity supply, causing a storage device associated with the distributed generation system to supply electricity to the electrical grid, and in response to determining that the demand is lower than a second predetermined amount of the available electricity supply, causing the storage device to store excess electricity supply.

In response to comparing the demand with the available electricity supply, the one or more processors may be caused to select the storage device from multiple storage devices based on at least one of state of charge of the storage device, or state of health of the storage device.

Causing the one or more storage devices to store the excess electricity supply may include adjusting a charging schedule of at least one of the multiple storage devices to be available for charging, increasing a battery charging rate of at least one of multiple storage devices, or controlling the distributed generation system via an electricity metering device of the plurality of metering devices.

In response to determining that the available electricity supply exceeds the demand, the one or more processors may be caused to send instructions to at least one of inverters of at least one of one or more distributed generation systems to reduce electricity supplied to the electrical grid by the at least one of one or more distributed generation systems.

The electricity usage data may include present electricity consumption data associated with the plurality of premises, present electricity generation data associated with the distributed generation system, historical electricity consumption data associated with the plurality of premises, and historical electricity generation data associated with the distributed generation system.

A system may comprise a plurality of electricity metering devices, where each electricity metering device is associated with, and capable of obtaining electricity usage data of, a corresponding premises of a plurality of premises in an electrical grid, and a server communicatively coupled to the plurality of electricity metering devices, the server hosting a distributed energy resource optimizer (DERO). The DERO may receive electricity usage data from the plurality of electricity metering devices, determine demand for electricity associated with the plurality of premises based at least in part on the electricity usage data, determine available electricity supply for the plurality of premises, compares the demand with the available electricity supply, in response to determining that the demand is higher than a first predetermined amount of the available electricity supply, cause one or more storage devices of one or more distributed generation systems associated with the plurality of premises to supplement the available supply by supplying electricity to the plurality of premises, and in response to determining that the demand is lower than a second predetermined amount of the available electricity supply, cause the one or more storage devices to store excess electricity supply over the demand in the one or more storage systems. The DERO, in response to comparing the demand with the available electricity supply, may select the one or more storage devices based on at least one of state of charge of the one or more storage devices, or state of health of the one or more storage devices.

The DERO may cause the one or more storage devices to store excess electricity supply by, at least one of: adjusting charging schedules of the one or more storage devices to be available for charging, increasing battery charging rates of the one or more storage devices, or controlling the one or more distributed generation systems via one or more electricity metering devices associated with the plurality of premises.

In response to determining that the available electricity supply exceeds the demand, the DERO may send instructions to one or more electricity metering devices associated with the one or more distributed generation systems to reduce electricity supplied by the one or more distributed generation systems to the electrical grid, and in response to receiving the instructions, the one or more electricity metering devices cause the one or more distributed generation systems to reduce electricity supplied to the plurality of premises.

The electricity usage data may include: present electricity consumption data associated with the plurality of premises, present electricity generation data associated with the distributed generation system, historical electricity consumption data associated with the plurality of premises, and historical electricity generation data associated with the distributed generation system.

An electricity metering device of the plurality of electricity metering devices may be a smart electricity meter associated with a premises of the plurality of premises, an electricity metering device associated with a distributed generation system of the one or more distributed generation systems, an electricity metering device associated with an electric vehicle (EV) telematics network of one or more EVs connected to the electrical grid, or an electricity metering device associated with an EV supply equipment (EVSE) network system associated with the electrical grid.

The DERO may determine the demand based on a demand level at a transformer associated with the plurality of premises, and the available electricity supply based on a supply level at the transformer.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
determining demand for electricity associated with a plurality of premises connected to an electrical grid, the plurality of premises including a distributed generation system associated with one of the plurality of premises;
determining available electricity supply for the plurality of premises;
comparing the demand with the available electricity supply;
in response to determining that the demand is higher than a first predetermined amount of the available electricity supply, supplementing the available electricity supply by causing a storage device associated with the distributed generation system to supply electricity to the electrical grid; and
in response to determining that the demand is lower than a second predetermined amount of the available electricity supply, storing excess electricity supply over the demand in the storage device.

2. The method of claim 1, further comprising:
in response to comparing the demand with the available electricity supply, selecting the storage device from multiple storage devices based on at least one of:
state of charge of the storage device, or
state of health of the storage device.

3. The method of claim 2, wherein storing the excess electricity supply in the storage device includes at least one of:
causing the storage device to be available for charging by adjusting a charging schedule of at least one of the multiple storage devices; or
increasing a charging rate of at least one of the multiple storage devices.

4. The method of claim 3, further comprising, in response to determining that the demand is lower than a second predetermined amount of the available electricity supply:
reducing electricity supplied by the distributed generation system to the electrical grid.

5. The method of claim 1, wherein determining the demand associated with the plurality of premises includes:
receiving electricity usage data of the plurality of premises; and
determining the demand based at least in part on the electricity usage data.

6. The method of claim 5, wherein receiving the electricity usage data of the plurality of premises includes receiving the electricity usage data from at least one of:
electricity metering devices associated with the plurality of premises,
the distributed generation system,
electric vehicle (EV) telematics of an EV connected to the electrical grid, or
an EV supply equipment (EVSE) associated with the electrical grid.

7. The method of claim 5, wherein the electricity usage data includes:
present electricity consumption data associated with the plurality of premises,
historical electricity consumption data associated with the plurality of premises,
present electricity generation data associated with the distributed generation system, and
historical electricity generation data associated with the distributed generation system.

8. The method of claim 7, wherein determining the demand associated with the plurality of premises further includes:
determining the demand based at least in part on the historical electricity consumption data associated with the plurality of premises.

9. The method of claim 5, further comprising:
providing a forecast to a utility provider associated with the plurality of premises based at least in part on the electricity usage data, the forecast including at least one of predicted demand, predicted available supply, or event recommendations.

10. The method of claim 1,
wherein determining the demand includes determining a demand level at a transformer associated with the plurality of premises, and
wherein determining the available electricity supply includes determining a supply level available at the transformer.

11. A distributed energy resource optimizer (DERO) comprising:
one or more processors; and
memory communicatively coupled to the one or more processors, the memory storing thereon computer executable instructions that, when executed by the one or more processors, cause the one or more processors to perform operations comprising:
receiving electricity usage data from a plurality of electricity metering devices associated with a plurality of premises;
determining demand for electricity at a transformer associated with the plurality of electricity metering devices connected to an electrical grid, the electrical grid including a distributed generation system associated with one of the plurality of premises;
determining available electricity supply at the transformer for the plurality of premises;
comparing the demand with the available electricity supply;
in response to determining that the demand is higher than a first predetermined amount of the available electricity supply, causing a storage device associated with the distributed generation system to supply electricity to the electrical grid; and
in response to determining that the demand is lower than a second predetermined amount of the available electricity supply, causing the storage device to store excess electricity supply.

12. The DERO of claim 11, wherein the operations further comprise:
in response to comparing the demand with the available electricity supply, selecting the storage device from multiple storage devices based on at least one of:
state of charge of the storage device, or
state of health of the storage device.

13. The DERO of claim 12, wherein causing the storage device to store the excess electricity supply includes:
adjusting a charging schedule of at least one of the multiple storage devices to be available for charging;
increasing a charging rate of at least one of the multiple storage devices; or
controlling the distributed generation system via an electricity metering device of the plurality of electricity metering devices.

14. The DERO of claim 11, wherein the operations further comprise:
in response to determining that the available electricity supply exceeds the demand, sending instructions to at least one of inverters of at least one of one or more distributed generation systems to reduce electricity supplied to the electrical grid by the at least one of one or more distributed generation systems.

15. The DERO of claim 11, wherein the electricity usage data includes:
present electricity consumption data associated with the plurality of premises,
present electricity generation data associated with the distributed generation system,
historical electricity consumption data associated with the plurality of premises, and
historical electricity generation data associated with the distributed generation system.

16. A non-transitory computer-readable storage medium storing thereon computer executable instructions that, when executed by one or more processors, cause the one or more processors to perform operations, the operations comprising:
receiving electricity usage data from a plurality of electricity metering devices associated with a plurality of premises;
determining demand for electricity at a transformer associated with the plurality of electricity metering devices connected to an electrical grid, the electrical grid including a distributed generation system associated with one of the plurality of premises;
determining available electricity supply at the transformer for the plurality of premises;
comparing the demand with the available electricity supply;
in response to determining that the demand is higher than a first predetermined amount of the available electricity supply, causing a storage device associated with the distributed generation system to supply electricity to the electrical grid; and
in response to determining that the demand is lower than a second predetermined amount of the available electricity supply, causing the storage device to store excess electricity supply.

17. The non-transitory computer-readable storage medium of claim 16, wherein the operations further comprise:
in response to comparing the demand with the available electricity supply, selecting the storage device from multiple storage devices based on at least one of:
state of charge of the storage device, or
state of health of the storage device.

18. The non-transitory computer-readable storage medium of claim 17, wherein causing the storage device to store the excess electricity supply includes:
adjusting a charging schedule of at least one of the multiple storage devices to be available for charging;
increasing a charging rate of at least one of the multiple storage devices; or
controlling the distributed generation system via an electricity metering device of the plurality of electricity metering devices.

19. The non-transitory computer-readable storage medium of claim 16, wherein the operations further comprise:
in response to determining that the available electricity supply exceeds the demand, sending instructions to one or more electricity metering devices of the plurality of electricity metering devices to reduce electricity supplied to the electrical grid by at least one of one or more distributed generation systems corresponding to the one or more electricity metering devices.

20. The non-transitory computer-readable storage medium of claim 16, wherein the electricity usage data includes:
present electricity consumption data associated with the plurality of premises,
present electricity generation data associated with the distributed generation system,
historical electricity consumption data associated with the plurality of premises, and
historical electricity generation data associated with the distributed generation system.
